(19) United States
(12) Patent Application Publication
(10) Pub. No.: US 2020/0114959 A1
(43) Pub. Date: Apr. 16, 2020

(54) VEHICLE LATERAL MOTION CONTROL

(71) Applicants: THYSSENKRUPP PRESTA AG, Eschen (LI); thyssenkrupp AG, Essen (DE)

(72) Inventors: Ádám VARGA, Budapest (HU); Péter KAKAS, Budapest (HU)

(73) Assignees: THYSSENKRUPP PRESTA AG, Eschen (LI); thyssenkrupp AG, Essen (DE)

(21) Appl. No.: 16/483,520

(22) PCT Filed: Feb. 17, 2017
(86) PCT No.: PCT/EP2017/053605

§ 371 Date: Aug. 5, 2019

(51) Int. Cl. B62D 6/00; B62D 15/02; B60W 30/045; B60W 40/114

(52) U.S. Cl. CPC B62D 6/003; B62D 15/025; B60W 2520/14; B60W 40/114; B60W 2520/06; B60W 30/045

(57) ABSTRACT

A motor vehicle power steering system for steering of a motor vehicle includes a rack and pinion steering gear, a path prediction module for determining a preliminary defined vehicle trajectory in response to data received from a plurality of vehicle state sensors, data of the motor vehicle power steering system, and further including a vehicle lateral motion control unit. The vehicle lateral motion control unit tracks the preliminary defined vehicle trajectory by minimizing the lateral deviation between the preliminary defined vehicle trajectory and the actual position of the vehicle by control of motor vehicle power steering system parameters.

The present invention relates to a motor vehicle power steering system according to the preamble of claim 1 and a method for lateral motion control of a vehicle according to the preamble of claim 9.

Lateral motion control of the vehicle is a key element of driver assistance systems such as e.g. lane keeping assistance, lane change assistance, curve driving assistance, straight driving assistance, traffic jam assistance, lateral acceleration control, collision avoidance, cooperative intersection collision avoidance, advanced lane guidance and other Advanced Driver Assistance Systems' (ADAS) related functionalities, which are necessary for realization of various level of ADAS, e.g. autonomous driving and automated driving.

Request signals outputted from such a driving assistance system are inputted into a lateral motion control apparatus that controls the amount of lateral motion (for example, the yaw rate) of the vehicle. Control signals are outputted from this control apparatus to a control target such as an actuator. The lateral motion of the vehicle is controlled as a result of the control target being controlled based on the control signals.

The lateral motion of a vehicle with a rack and pinion steering gear can be controlled by rack position control, rack force control or motor torque control of the steering assist.

Drawback of this method is that the resulting vehicle kinematics cannot be directly controlled. If for example a vehicle is traveling along a curve where the road surface has a low coefficient of friction because of ice or snow the lateral motion of the vehicle cannot be controlled with satisfactory quality.

It is an object of the present invention to provide an electromechanical motor vehicle power steering system that easily and reliably allows lateral motion control of the vehicle.

This object is achieved by a motor vehicle power steering system having the features of claim 1 and by a method having the features of claim 9.

A motor vehicle power steering system for steering of a motor vehicle with a rack and pinion steering gear, a path prediction module for determining a preliminary defined vehicle trajectory in response to data received from a plurality of vehicle state sensor and data of the motor vehicle power steering system, and a vehicle lateral motion control unit, is provided, wherein the vehicle lateral motion control unit is tracking the preliminary defined vehicle trajectory by minimising the lateral deviation between the preliminary defined vehicle trajectory and the actual position of the vehicle by control of the motor vehicle power steering system parameters. This way the lateral optimization takes place with respect to the vehicle trajectory taking into account the actual position of the vehicle and for example external influences, which makes the motion control of the vehicle much better.

Preferably the control of the motor vehicle power steering system parameters includes control of the steering forces, e.g. the rack force request and/or motor torque request of the steering system and/or motor current request of the steering system.

It can also be advantageous if the control of the motor vehicle power steering system parameters includes control of a position request. This position request can compromise the front wheel angle and/or the rack position and/or the pinion angle.

It is preferred, if the vehicle lateral motion control unit is tracking the preliminary defined vehicle trajectory in response to data received from a plurality of vehicle state sensor, data of the motor vehicle power steering system and the output of the path prediction module.

The motor vehicle power steering system can be an electromechanical steering system or a steer-by-wire-steering system with ADAS levels ranging from automated driving to autonomous driving.

Further a method for lateral motion control of a motor vehicle with a motor vehicle power steering system comprising a rack and pinion steering gear and an electric motor, is provided, said method comprising the steps of:
Operating a path prediction module to determine a preliminary defined vehicle trajectory in response to data received from a plurality of vehicle state sensor and data of the motor vehicle power steering system;
Determining the actual position of the vehicle and a lateral deviation between the preliminary defined vehicle trajectory and the actual position;
Tracking the preliminary defined vehicle trajectory by minimising the lateral deviation between the preliminary defined vehicle trajectory and the actual position of the vehicle by control of the motor vehicle power steering system parameters with a vehicle lateral motion control unit.

This way the lateral optimization takes place with respect to the vehicle trajectory taking into account the actual position of the vehicle and for example external influences, which makes the motion control much better.

Preferably the control of the motor vehicle power steering system parameters includes control of the steering forces, e.g. the rack force request and/or motor torque request of the steering system and/or motor current request of the steering system.

It can also be advantageous if the control of the motor vehicle power steering system parameters includes control of a position request. This position request can compromise the front wheel angle and/or the rack position and/or the pinion angle.

It is preferred, if the vehicle lateral motion control unit is tracking the preliminary defined vehicle trajectory in response to data received from a plurality of vehicle state sensor, data of the motor vehicle power steering system and the output of the path prediction module.

The motor vehicle power steering system can be an electromechanical steering system or a steer-by-wire-steering system with ADAS levels ranging from automated driving to autonomous driving.

Two exemplary embodiments of the present invention are described below with aid of the drawings. In all figures the same reference signs denote the same components or functionally similar components.

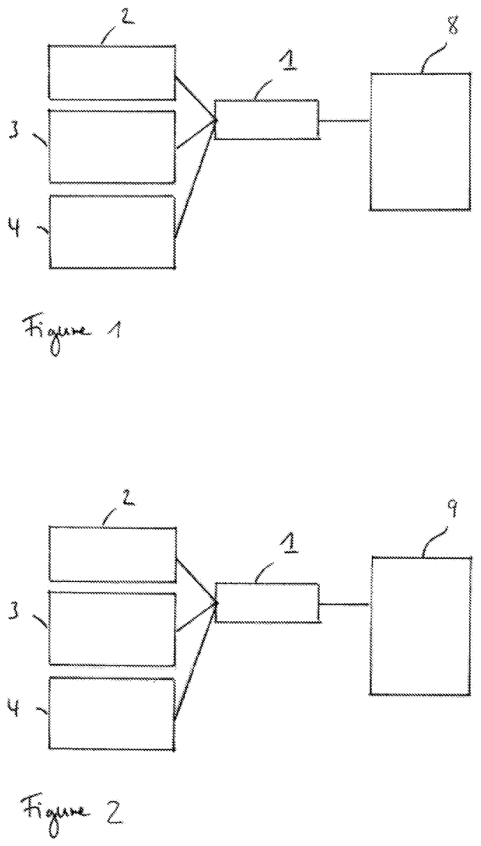

FIG. 1 shows a schematic illustration of a method for vehicle lateral motion control of a first embodiment;

FIG. 2 shows a schematic illustration of a method for vehicle lateral motion control of a second embodiment, and

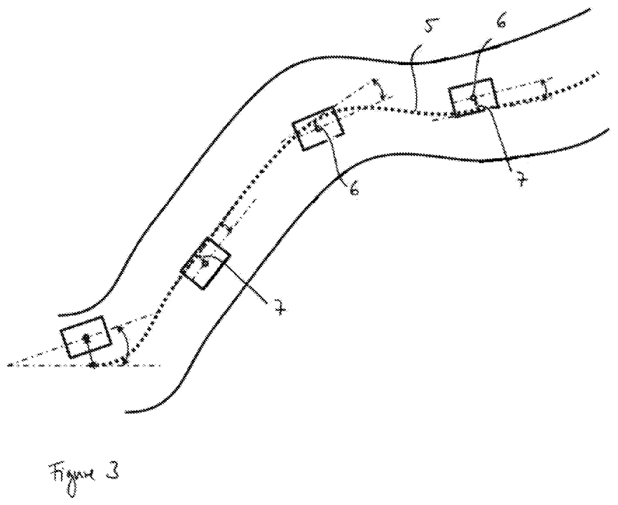

FIG. 3 shows a schematic illustration of a vehicle traveling along a curvy road with its preliminary defined reference trajectory and its actual position.

The vehicle lateral motion control unit 1, as shown in FIGS. 1 and 2, is given measured and/or estimated signals of the vehicle state 2 (e.g. vehicle speed, vehicle acceleration, rotational speed, vehicle yaw rate, vehicle lateral acceleration, vehicle heading, integrated vehicle heading etc.), measured and/or estimated signals of the electromechanical motor vehicle power steering system 3 (e.g. pinion torque, steering wheel torque) and relative position signals of the vehicle with respect to road features 4 (e.g., lane marker(s), road shoulder(s), median barrier(s), or other road features) or generated position points, which represent the vehicle lateral deviation from the reference trajectory.

A reference trajectory 5 is a driver intended path or future path of the vehicle on the road, as shown in FIG. 3, and it is defined based on the road features 4 given by environment sensing (e.g. camera, radar, sensor fusion). Preferably, a 3-D map with the environment information is created, containing object positions, lane markings and all constrains according to the public road rules. The relative position of the vehicle 6 with respect to the preliminary defined trajectory 5 can be given based on GPS location data of the vehicle, data from a digital map, data from one or a plurality of vehicle motion sensors and/or other data regarding the vehicle, including measured relative distance to road features, or other information known in the art. The vehicle lateral motion control unit 1 controls the vehicle lateral motion tracking the predefined trajectory 5 based on the determined actual position 6 of the vehicle and an occurring lateral deviation 7 between the reference trajectory 5 and the actual position 6. The vehicle lateral motion control unit 1 has a vehicle state based feedback controller. The vehicle state can include all or only some of the following signals: vehicle yaw rate, vehicle lateral acceleration, vehicle speed, vehicle heading, vehicle position, integrated vehicle heading, integrated vehicle position. The controller contains a state, which describes some part of the dynamic behavior of the vehicle regarding the yaw rate and/or lateral acceleration. This dynamic behavior can be represented by a transfer function e.g. low pass filter, which can be time based and/or length based. The equitation of states can be time based or length based as well. The vehicle state is then interpreted in a reference trajectory based or vehicle based coordinate system or absolute coordinate system. The controller is a state based feedback controller. The controller can be designed with any possible control method e.g. linear-quadratic-Gaussian, model predictive or Ackerman's formula etc. The vehicle lateral motion control unit 1 then calculates the rack force and/or motor torque request and/or motor current request 8 needed to minimize the occurring deviations, as shown in FIG. 1.

In the second embodiment, shown in FIG. 2, the vehicle lateral motion control unit 1 influences the steering system position request 9 (e.g. the front wheel angle and/or rack position and/or pinion angle etc.) e.g. via position control.

The vehicle lateral motion control unit 1 is able to control the vehicle lateral motion by path tracking.

[symbol]

1.-16. (canceled)

17. A motor vehicle power steering system for steering of a motor vehicle, comprising:
a rack and pinion steering gear,
a path prediction module configured to determine a preliminary defined vehicle trajectory in response to data received from a plurality of vehicle state sensors and data of the motor vehicle power steering system, and
a vehicle lateral motion control unit configured to track the preliminary defined vehicle trajectory by minimizing lateral deviation between the preliminary defined vehicle trajectory and an actual position of the vehicle by controlling parameters of the motor vehicle power steering system.

18. The motor vehicle power steering system of claim 17, wherein the control of the motor vehicle power steering system parameters includes control of a rack force request and/or a motor torque request of the steering system and/or a motor current request of the steering system.

19. The motor vehicle power steering system of claim 17, wherein the control of the motor vehicle power steering system parameters includes control of a position request.

20. The motor vehicle power steering system of claim 19, wherein the position request comprises a front wheel angle.

21. The motor vehicle power steering system of claim 19, wherein the position request comprises a rack position.

22. The motor vehicle power steering system of claim 19, wherein the position request comprises a pinion angle.

23. The motor vehicle power steering system of claim 17, wherein the vehicle lateral motion control unit tracks the preliminary defined vehicle trajectory in response to data received from the plurality of vehicle state sensors, data of the motor vehicle power steering system and output of the path prediction module.

24. The motor vehicle power steering system of claim 17, wherein the motor vehicle power steering system is an electromechanical steering system or a steer-by-wire-steering system.

25. A method for lateral motion control of a motor vehicle with a motor vehicle power steering system comprising a rack and pinion steering gear and an electric motor, said method comprising the steps of:
operating a path prediction module to determine a preliminary defined vehicle trajectory in response to data received from a plurality of vehicle state sensors and data of the motor vehicle power steering system;
determining the actual position of the vehicle and a lateral deviation between the preliminary defined vehicle trajectory and the actual position; and
tracking the preliminary defined vehicle trajectory by minimizing the lateral deviation between the preliminary defined vehicle trajectory and the actual position of the vehicle by controlling the motor vehicle power steering system parameters with a vehicle lateral motion control unit.

26. The method of claim 25, wherein the control of the motor vehicle power steering system parameters includes controlling a rack force request and/or a motor torque request of the steering system and/or a motor current request of the steering system.

27. The method according to claim 25, wherein the control of the motor vehicle power steering system parameters includes controlling a position request.

28. The motor vehicle power steering system of claim 27, wherein the position request comprises a front wheel angle.

29. The method of claim 27, wherein the position request comprises a rack position.

30. The method of claim 27, wherein the position request comprises a pinion angle.

31. The method of claim 25, wherein the vehicle lateral motion control unit tracks the preliminary defined vehicle trajectory in response to data received from the plurality of vehicle state sensors, data of the motor vehicle power steering system and the output of the path prediction module.

32. The method of 25, wherein the motor vehicle power steering system is an electromechanical steering system or a steer-by-wire-steering system.
